(19) United States
(12) Patent Application Publication
(10) Pub. No.: US 2023/0316954 A1
(43) Pub. Date: Oct. 5, 2023

(54) NEUROSIM - A PORTABLE AND COST-EFFECTIVE NEUROLOGICAL SIMULATION DEVICE TO PRACTICE OPERATIVE SKILLS

(71) Applicant: The Regents of the University of California, Oakland, CA (US)

(72) Inventors: Alexander Lopez, Playa Del Rey, CA (US); Nischal Acharya, Woodburry, MN (US); Chen Yi Yang, San Diego, CA (US); Joshua Kurtz, El Cajon, CA (US); Michael Oh, Irvine, CA (US)

(73) Assignee: The Regents of the University of California, Oakland, CA (US)

(21) Appl. No.: 18/112,835

(22) Filed: Feb. 22, 2023

Related U.S. Application Data
(60) Provisional application No. 63/312,807, filed on Feb. 22, 2022.

(51) Int. Cl. G09B 23/30; G09B 23/34

(52) U.S. Cl. CPC G09B 23/306; G09B 23/303; G09B 23/34

(57) ABSTRACT

A simulation device for simulating a surgical procedure includes an open box and a three-dimensional model of a bony or soft tissue anatomical structure that is positionable in the open box. A box cover is positionable over the open box. Advantageously, the box cover includes surface structures that simulate anatomical structures relevant to the surgical procedure.

### CROSS-REFERENCE TO RELATED APPLICATIONS

This application claims the benefit of U.S. provisional application Serial No. 63/312,807 filed Feb. 22, 2022, the disclosure of which is hereby incorporated in its entirety by reference herein.

### STATEMENT REGARDING FEDERALLY SPONSORED RESEARCH OR DEVELOPMENT

The invention was made with Government support under Contract No. N/A awarded to UCI Neurosurgery Innovation Award. The Government has certain rights to the invention.

### TECHNICAL FIELD

In at least one aspect, a surgical simulation device that allows for a plurality of surgical procedures to be simulated is provided.

### BACKGROUND

Neurosurgery remains one of the most technically challenging specialties, with data suggesting 23.7% to 27.8% of neurosurgical errors are attributed to procedural errors during surgery¹. There is a paucity of intraoperative opportunities for trainees to learn the required skills to repair an incidental durotomy, given the high complexity and comorbidities associated with the procedure. A simulation device may improve resident technical abilities to potentially improve trainee ability, reduce patient risk, and increase confidence in the operating room. Current lumbar dural repair simulators use cadaveric models or immobile simulators^{2,}³. Virtual reality simulators like ImmersiveTouch and NeuroTouch are expensive and lack portability. Additionally, virtual reality simulators lack the haptic feedback required to replicate surgery⁴. These features limit their functionality in training⁴.

Accordingly, there is a need for improved surgical simulators.

### SUMMARY

In at least one aspect, a simulation device for simulating a surgical procedure is provided. The simulation device includes an open box and a three-dimensional model of a bony anatomical structure that is positionable in the open box. A box cover is positionable over the open box. Advantageously, the box cover includes surface structures that simulate anatomical structures relevant to the surgical procedure being simulated.

In another aspect, a portable and affordable simulation device that enables trainees to supplement their training by practicing surgical procedures in a low-stress environment is provided.

In another aspect, a cost-effective, reusable, and mobile microdiscectomy simulator that can be used for resident training is provided.

In another aspect, an affordable and portable lumbar dural repair device that can also simulate many surgical scenarios is provided.

Advantageously, the simulation boxes provided herein allow for models of multiple surgical procedures to be used in a single simulation system.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIGS. 1A and 1B. Side views of a simulation device for simulating surgical procedures.

FIGS. 2A, 2B, 2C, 2D, 2E, and 2F. Schematic illustrations of a simulation box for spinal dura repair.

FIGS. 3A, 3B, 3C, and 3D. Schematic illustrations of a simulation box for microdiscectomy.

FIGS. 4A, 4B, 4C, and 4D. Schematic illustrations of a simulation box for transsphenoidal hypophysectomy.

FIG. 5. Engineering schematic of a simulation box.

FIGS. 6A, 6B, 6C, 6D, and 6E. Schematics of an anterior cervical discectomy and fusion simulation

FIGS. 7A, 7B, 7C, 7D, and 7E. Schematics of an anterior lumbar interbody fusion simulation.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/- 5% of the value. As one example, the phrase “about 100” denotes a range of 100+/- 5, i.e. the range from 95 to 105. Generally, when the term “about” is used, it can be expected that similar results or effects according to the invention can be obtained within a range of +/- 5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ± 0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4.... 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

Throughout this application, where publications are referenced, the disclosures of these publications in their entireties are hereby incorporated by reference into this application to more fully describe the state of the art to which this invention pertains.

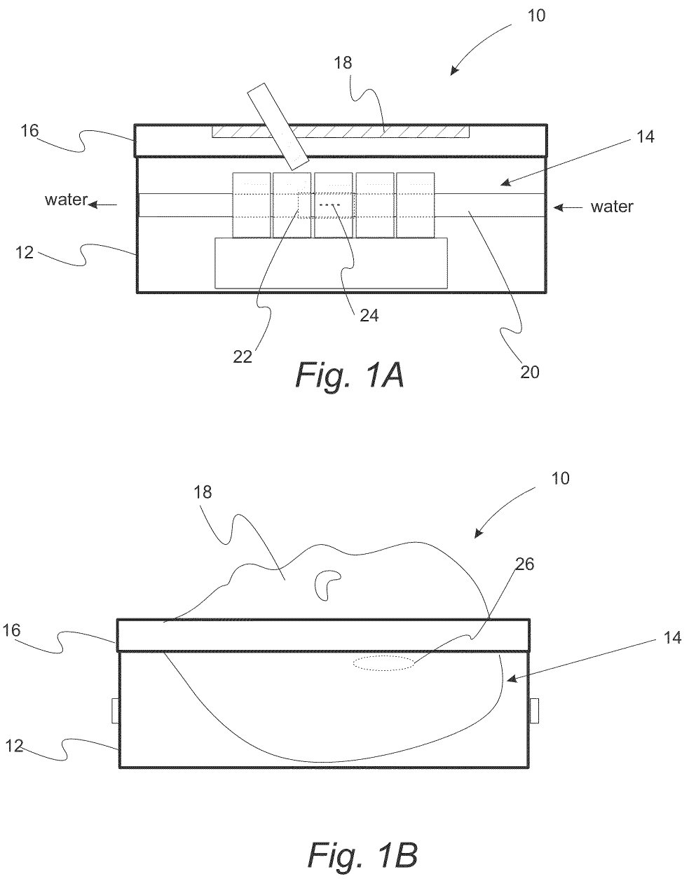

With reference to FIGS. 1A and 1B, side views of a simulation device for simulating surgical procedures are provided. Simulation box 10 includes an open box 12. Three-dimensional model 14 of a bony anatomical structure is positionable in the simulation box. Box cover 16 is positionable over the open box 12. Advantageously, box cover 16 has surface structures 18 that simulate anatomical structures relevant to a surgical procedure being simulated. Examples of surface structures include skin, bony structures close to the skin, and a combination thereof. A portion of a human skull is an example of a specific surface structure close to the skin that can be included on box cover 16.

In some variations, three-dimensional model 14 can be divided into multiple sections held together by magnets. In a refinement, this magnetic technology can be designed to only withstand the maximal force a surgeon should apply when performing a procedure. If this force is exceeded, the trainee will displace the simulated anatomic structure, learning to understand the correct force required to perform surgery. In other variations, three-dimensional model 14 can be divided into multiple sections held together by protrusions, and it can open to allow easy insertion of the protrusions. This methodology to connect sections of the model provides a more robust joining of the sections.

In another variation, three-dimensional model 14 includes a replaceable component that simulates material altered or removed by a surgical procedure. For example, molding clay can be used to simulate a tumor that is removed. As set forth below, a dura substitute material can be used to simulate a spinal dura rupture that has to be sutured together.

Three-dimensional model 14 can be created to simulate a patient’s bony anatomical structures using a patient’s imaging data (CT scan, MRI images, and the like). The model can be created from de-identified patient scanning data. Alternatively, the three-dimensional model 14 can be created from patient-specific imaging data. This latter refinement is particularly useful when a patient’s medical condition present atypical surgical issues.

FIG. 1A illustrates a simulation box suitable to simulate spinal surgical procedures such as spinal dura repair and microdiscectomy. In this simulation box, plastic tube 20 is used to mimic a patient’s spinal canal. A portion of plastic tube 20 is surrounded by a dura substitute material 22 to simulate spinal dura. Examples of useful materials for the simulated spinal dura material 22 include but are not limited to bovine pericardium used as a dura substitute, leather, oriented polypropylene wrapping, chicken skin, latex, and the like. In a refinement, a small incision 24 can be made on the dura substitute to simulate an incidental durotomy (i.e., a perioperative complication in which the spinal dura ruptures and CSF leaks out from the spinal canal). Water can be pumped through plastic tube 14 to simulate cerebrospinal fluid (CSF) pressure and flow.

In the variation of FIG. 1A, surface structure 18 includes a synthetic covering that mimics skin and provides a narrow surgical viewing plane. Examples of materials for this synthetic covering include, but are not limited to, foam insulation, silicone, or ballistics gel.

In the variation of FIG. 1A, a tubular retractor (e.g., 3D-printed tubular retractor) can be placed on the box cover 16 to simulate an endoscopic approach to a patient’s spine from the patient’s back.

In the variation of FIG. 1B, illustrates a simulation box suitable for spinal surgeries such as transsphenoidal hypophysectomy. In this variation, surface structures 18 simulate a first portion of a human skull while three-dimensional model 14 simulates a second portion of the human skull. Three-dimensional model 14 also includes a plastic structure 26 simulating the pituitary gland.

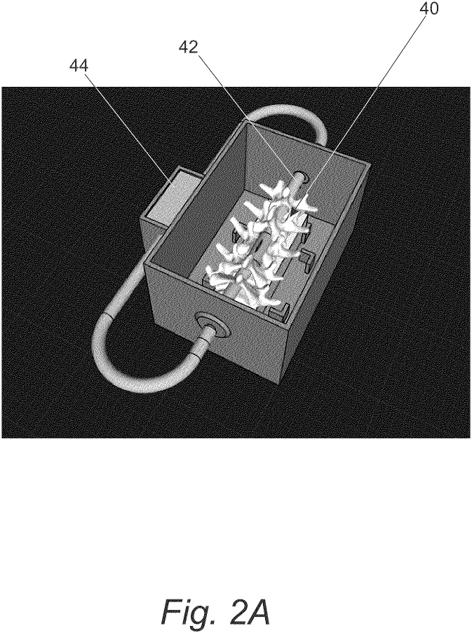

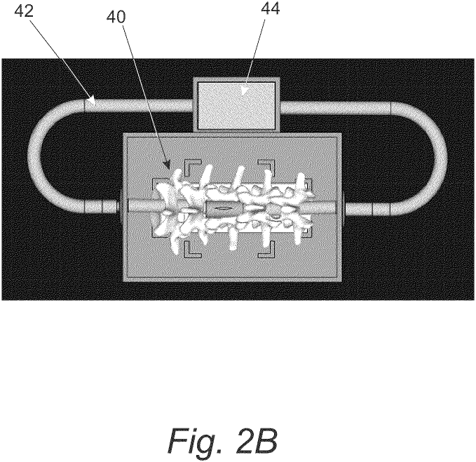

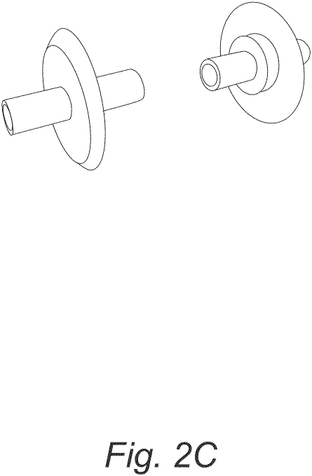

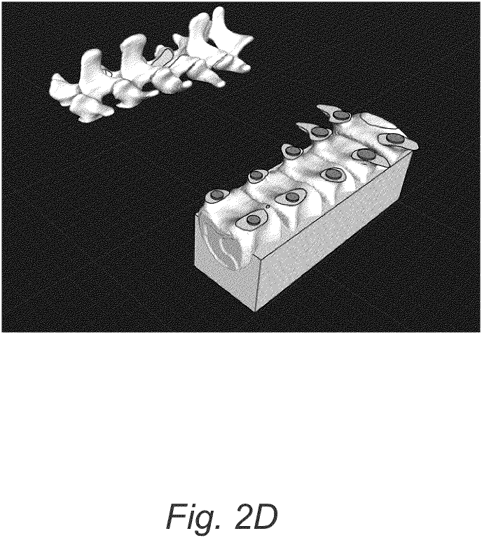

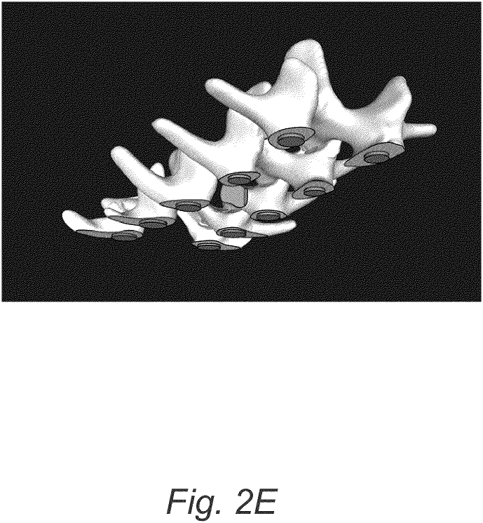

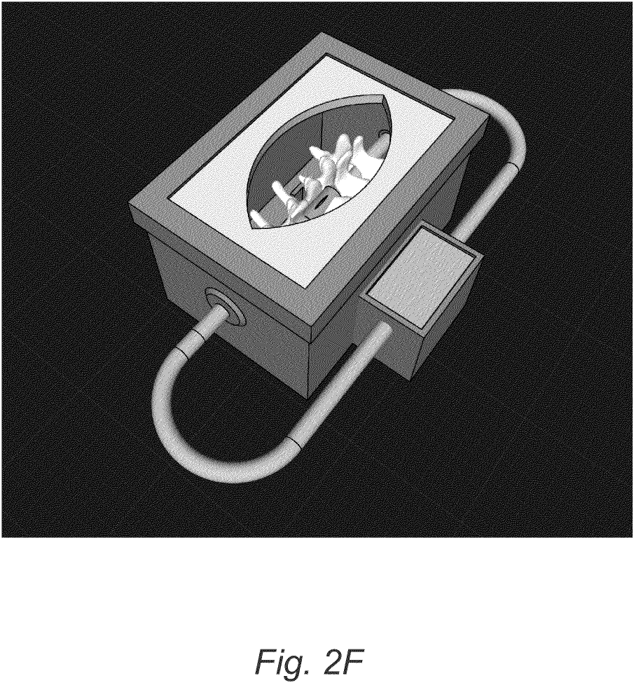

With reference to FIGS. 2A, 2B, 2C, schematic illustrations of a simulation box for spinal dura repair is provided. FIG. 2A provides a perspective view of this simulation box which is referred to as a “Neurosim Box.” FIG. 2B provides a top view of the Neurosim Box. A patient’s CT scan can also be used to create a 3D model 40 of bony structures and soft tissue, which can then be 3D printed or molded to mimic patient anatomy. In a refinement, a de-identified patient CT scan can be used to create this model. In another refinement, patient-specific scans can be used. Plastic tubes 42 mimic the spinal canal and are connected to a water pump system 44 that simulates CSF flow using colored fluid for leak visualization. A synthetic liquid reservoir with a pump enables pressurization of the tube to evaluate the integrity of placed suture. Dura material 16 is disposed over the tubes.

FIG. 2C provides a perspective view of the tube outlets. The tube outlets enable a water-tight seal between the spinal canal, the NeuroSim box, and fluid plumbing tubes.

FIGS. 2D and 2E provide perspective views of a novel magnetic attachment technology for medical simulation devices set forth herein. FIG. 2D illustrates a detachable spinous processes of the lumbar spine. The upper left component illustrates detachable vertebral bodies of the lumbar spine. Gray cylinders indicate the attachment sites of magnets. The lower right component illustrates an inferior aspect of the detachable spinous processes of the lumbar spine. Gray cylinders indicate attachment sites of magnets. The implementation of magnets for quick removal of anatomical structures is currently implemented for easy removal and access to the interior spinal canal. However, this idea can be implemented in many contexts, especially for weakly attaching two anatomical structures. For example, it can be implemented to assess whether surgeons are exerting too much force upon an anatomical structure. For example, if the drilling on the top of the skull can only support a certain amount of force. In a refinement, this magnetic technology can be designed to only withstand the maximal force a surgeon should apply when performing a procedure. If this force is exceeded, the trainee will displace the simulated anatomic structure, learning to understand the correct force required to perform surgery. Moreover, this technology allows for increased reusability. For example, after one of the pieces is used during a simulation training, that single piece can be replaced with another unaltered piece. This increases the reusability of the device, as less material will need to be replaced per trial run. The implementation of magnets in surgical simulation devices is highlighted.

FIG. 2F provides a perspective view of a surgical opening in the simulated skin for this variation. Larger retractors can be used to hold the skin and tissue open in such surgical openings.

As with other models, a protocol to assess surgical performance over time was designed. Specifically, this can be measured through the time to repair the dura, the volume of CSF lost during repair, and the integrity of repair by measuring the required pressure to rupture the seal.

In another variation, the simulation box technology can be used to simulate microdiscectomy. Minimally invasive surgery is becoming increasingly favorable due to patients’ reduction in postoperative pain and shorter hospital stays. In order to become proficient in these techniques, simulation exercises are beneficial to resident education. Simulation exercises in surgical residencies have been shown to foster confidence and improve trainee surgical techniques. For neurosurgical residents, the main form of practice involves cadaveric dissection. While cadavers well formulate human anatomy, the maintenance of these bodies, cost to purchase, dedicated space, and exposure to toxic chemicals are just some of the limitations. Therefore, this variation provides a cost-effective, reusable, and mobile microdiscectomy simulator that can be used for resident training.

This box was created using a similar protocol to the spinal dura repair. The same box was used as the spinal dura repair, and additional L-brackets were constructed at the bottom to accommodate this anatomical model. The lumbar spine included the levels L4 and L5, although any spine level can be used. A tubular retractor was created to closely mimic endoscopic surgery. Through this retractor, the trainee will place an endoscope and the desired surgical tool (in this case, pituitary forceps) to perform surgery using a camera system that connects to an external display. This will not only train the user to operate in a restricted environment but also provide the hand-eye coordination required to operate using an external camera system (which is shown in a 2D plane) instead of relying on normal 3D vision of the surgical field. Foam was placed around the tubular retractor to mimic patient skin, provide tactile feedback to the user, and further simulate a narrow operating field. However, multiple materials can be substituted for foam, including silicone and ballistics gel. A cost-effective spine simulator that mimics patient anatomy was successfully developed and created. In addition, the simulator allows for easy transportation, where users can bring the box with them wherever they go.

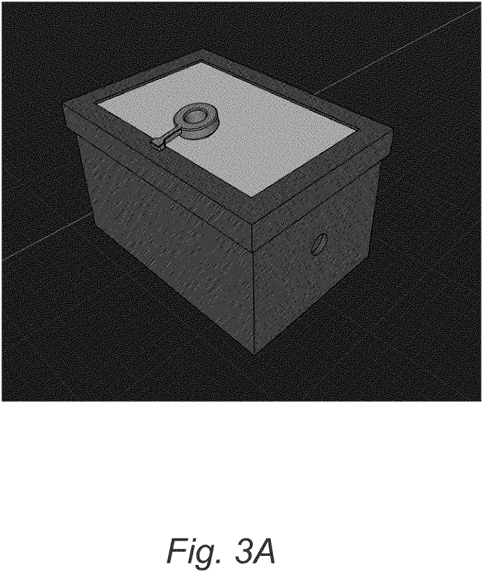

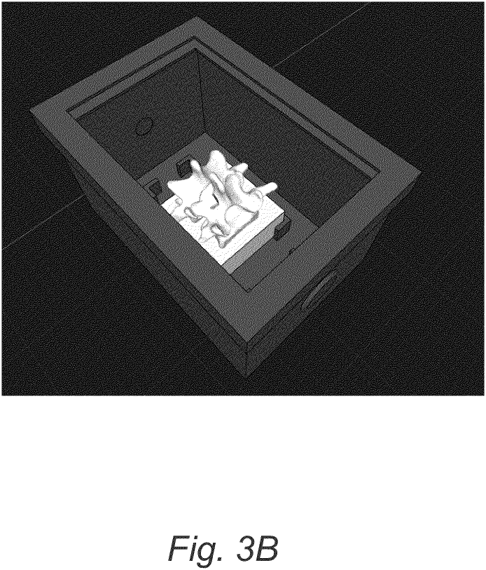

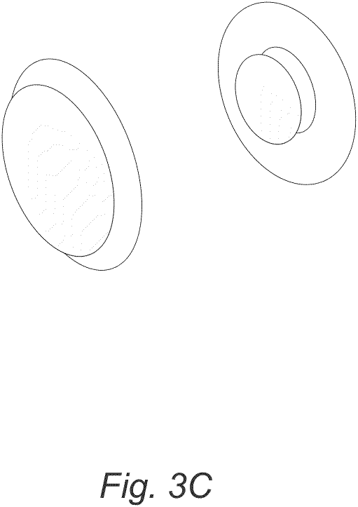

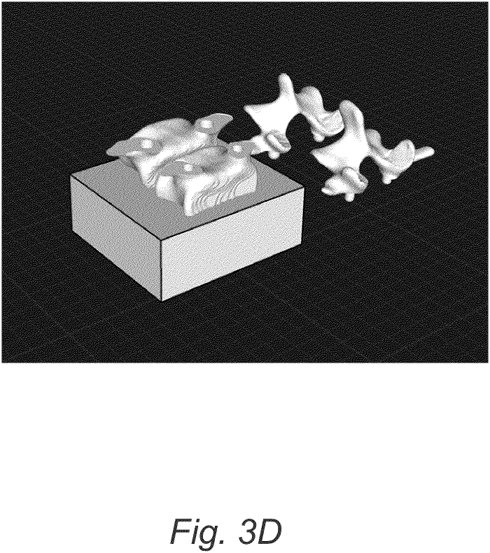

FIG. 3A provides a perspective view of a NeuroSim box for microdiscectomy. The lighter portion is a material to simulate skin. Currently, foam material is used, but this can also be substituted with other synthetic soft-tissue materials (e.g., silicone, ballistics gel). The grey tubular structure is a retractor that is used to simulate the operating field in minimally invasive surgery. This is the entry point for the endoscope and surgical tools.

FIG. 3B provides a perspective view of the inner microdiscectomy box. The white inner portion is a 3D-printed spine from a de-identified patient CT scan. The 3D printed spine is secured in the box with built-in L-brackets that hold the structure in place. FIG. 3C provides a perspective view of plugs placed in the holes of the box. Because this is the same box used in the other (which requires a water pump), these plugs will prevent light from entering the inside of the box, mimicking the visual field provided when operating on the human body

FIG. 3D provides a perspective view of a representation of a 3D printed spine with detachable spinous processes from the vertebral body. The implementation of pegs allows for a quick and durable connection between the vertebral bodies and spinous processes. The top portion of the spine is where the user will most likely be drilling to expose the intervertebral disc space, so it is very convenient and cost-effective to be able to easily replace this portion.

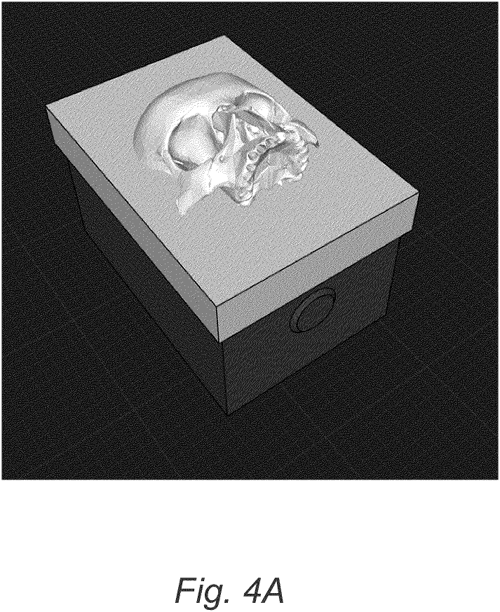

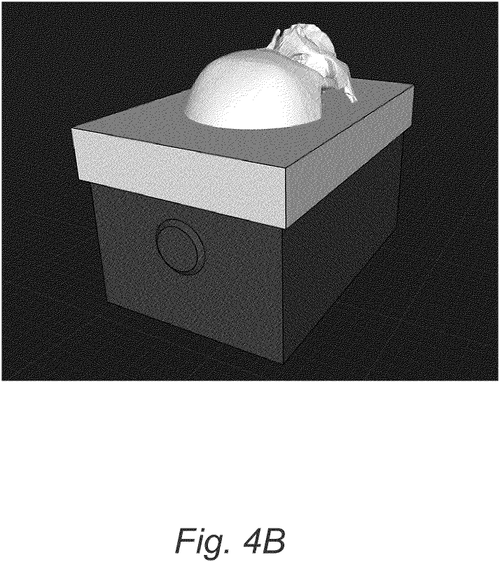

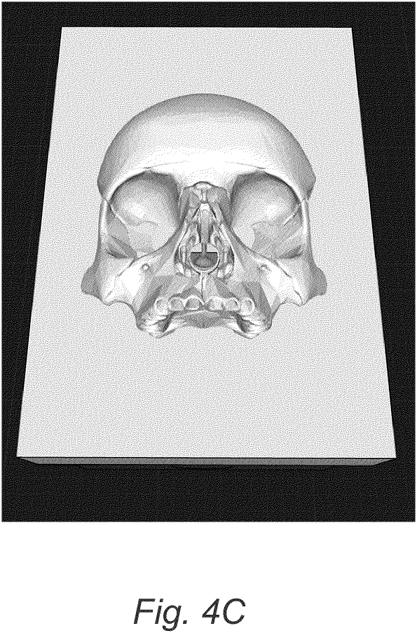

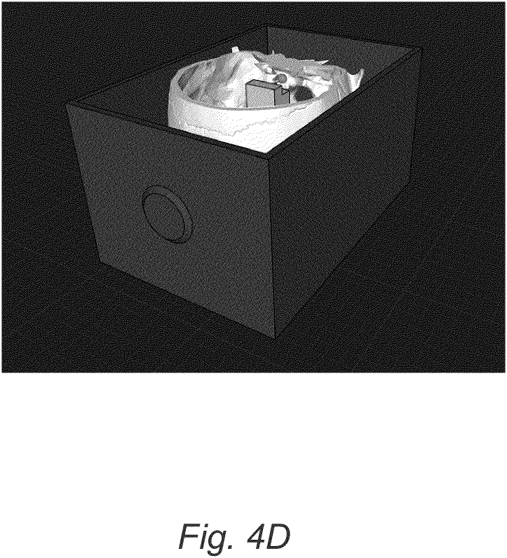

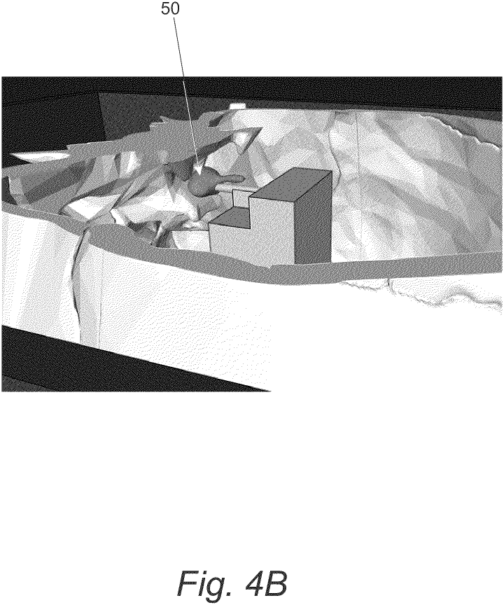

FIGS. 4A to 4D provide schematics relevant to pituitary tumor resection (aka transsphenoidal hypophysectomy). Cranial operations require extensive operative skills and training, with a previous study reporting a total error rate of 67.9% across 859 cranial surgeries. 1 Recent advance in endoscopic approaches to skull base tumors have created a new opportunity for neurosurgeons to access obscure regions through minimally invasive techniques; however, these procedures are complex and require high expertise to perform.²

Like both previous models, this simulation was created to be used in the same box. While the figures below depict a human skull from the internet, a skull using a head MRI scan from a de-identified patient can be utilized. This model was manipulated to provide visualization of the anterior portion of the pituitary gland, which is typically accessed through the nasal canal. However, another application of this device is to use a surgical drill to access the pituitary gland, in which case no initial entry point would be provided. A model pituitary gland was created using silicone gel. However, like most other materials, this can be substituted with ballistics gel, modeling clay, playdoh, etc. Modeling clay can be placed on the pituitary gland to mimic a tumor, which can then be resected using surgical tools. Like the microdiscectomy model, this simulation was designed to include an endoscope with an external camera system, as all tumor resections through the nasal canal are performed using a scope. Another possibility is placing a camera system inside the box to provide the same visual plane.

FIGS. 4A, 4B, and 4C provide perspective views of a simulation box relevant to transsphenoidal hypophysectomy. The insertion point of the endoscopic tools and resection of a tumor will occur through the nasal opening (shown in the third image). FIGS. 4D and 4E provide inside perspective views with the cranial base of the 3D-printed skull. The gray base in the middle of the skull opening is used to secure the pituitary gland. The pituitary gland is depicted with item number 50.

In a refinement of this simulation, two major complications that can arise through this surgery can be simulated:

Damage to the optic chiasm: This anatomical structure is located just behind the pituitary gland, so if a surgeon were to damage this area, it could result in visual defects or even blindness. A feedback system can be provided that will alert the user if they accidentally touch this area. This will include running an electrical circuit through the simulated optic chiasm (which could be made using modeling clay, among other materials) that is attached to a red-colored light. When the user touches this circuit with their surgical tool (made of metal), the red light will turn on.

Damage to the carotid arteries: these blood vessels are located adjacent to the pituitary gland, essential to providing blood to the brain. If an operation results in damage to these arteries, the patient can bleed out or have serious neurological deficits. Similar to the optic chiasm, the carotid arteries using modeling clay and running an electric circuit through them attached to a red light can be simulated. When the user touches these structures, they will be alerted to their mistake through the light circuit system.

### Other Potential Applications

Any cranial/spine surgery involving endoscopic or open surgery approaches: Because this box relies on CT/MRI imaging and actual patient anatomy, a wide range of neurosurgical operations can be simulated with this box. The only requirement is that the structures can be placed within the confines of the box. Although two different sets of L-brackets are used, these can be adjusted to accommodate a multitude of different structures. Furthermore, the size of the box can also be altered to compensate for any larger anatomical models.

### Feedback Systems

Using color-changing chemicals to determine whether the tumor is sufficiently separated. A major obstacle with resecting tumors from the body is the determination of clean margins and complete resection. To determine if a user has removed all parts of the tumor, a thermosensitive material can be created that would change color when exposed to a certain non-hazardous fluid (e.g., warm water). Pouring fluid into the surgical field will allow the user to determine the extent of complete resection.

Screw placement: the current PLA filament being used is capable of holding screws. As a large majority of surgical operations involve placing screws to hold anatomical structures in place (e.g., spine vertebrae for stabilization, parts of the skull that were initially removed for surgery and need to be placed back), this device can allow users to practice correct screw placement.

Deep tissue suturing. Although many suturing kits are currently available commercially, there is a lack of models that effectively mimic suturing deeper tissues in the body. For example, to access the spine, surgeons need to cut through multiple layers of skin, soft tissue, muscle, etc., and these layers need to be stitched back together after the surgery to promote adequate healing. Synthetic materials similar to these layers can be used that can be cut apart and sutured back together to teach trainees how to properly close a surgical wound. Aside from this example, this can be applied to the layers of tissue all over the body (e.g. the scalp or hip).

Although the simulations set forth above typically only need surgical forceps (aka pituitary forceps) and/or an endoscope with an external camera system, the surgical simulation box can also be used to practice other tools, such as cauterizers (used to stop bleeding and seal blood vessels), irrigation tools (used to clean the field of view), and retractors (currently modeling a tubular retractor, but there are countless other tools available that can also be modeled to provide a different view of the surgical field).

### Foreseeable Benefits of Neurosim

1. Personal skills improvement in medical students, residents, attendings

Partnership with medical schools

Partnership with residency programs

2. Recording of performance with increased practice

Partnership with medical device companies to evaluate performance

The following examples illustrate the various embodiments of the present invention. Those skilled in the art will recognize many variations that are within the spirit of the present invention and scope of the claims.

### 1. Fabrication of a NeuroSim Box

The simulation box was designed using Shapr3D and 3D printed using the Original Prusa i3 MK3S+. Notably, all of the following simulations can be performed in the same simulation box (shown in the figures below). To maximize anatomic resolution, the HATCHBOX PLA filament was selected. The model lumbar spine was constructed from a de-identified patient lumbar CT scan and segmented using PrusaSlicer and manipulated to include an L3-L4 laminectomy. To simulate the thecal sac, a tube was placed through the lumbar spine and bovine pericardium was wrapped around the tube at the L3-L4 region to simulate the dura mater. Although bovine pericardium was used as a dura substitute, a large variety of materials can be used to simulate spinal dura mater, including but not limited to: leather, oriented polypropylene wrapping, chicken skin, and latex. A small water pump was used to simulate cerebrospinal fluid (CSF) pressure and flow. A small incision was made on the dura substitute to simulate an incidental durotomy (a perioperative complication in which the spinal dura ruptures and CSF leaks out from the spinal canal). A synthetic covering was used to mimic skin and provide a narrow surgical viewing plane. This substitute can also come from a wide range of materials, such as foam insulation, silicone, or ballistics gel. (It should be pointed out that dura repair surgery is not typically performed using a tubular retractor. It is performed during open surgery. Instead, you can use any type of retractor (e.g., Weitlaner retractor)). To mimic intraoperative practice, users must practice suturing the simulated dura tissue to create a water-tight seal and prevent CSF leakage after closure. This can be tested by running the water pump after closure to increase pressure on the now-sutured dura substitute, which may leak if the water-tight seal has not been achieved.

### 2. Development of a Modular, Portable, and Affordable Surgical Simulation Device for Lumbar Dural Repair

### Materials and Methods

The simulation box was designed using Shapr3D and 3D printed using the Original Prusa i3 MK3S+. To maximize anatomic resolution, the HATCHBOX PLA filament was selected. The model lumbar spine was constructed from a de-identified patient lumbar CT scan and segmented using Slicer and manipulated to include an L3-L4 laminectomy. To simulate the thecal sac, a tube was placed through the lumbar spine, and bovine pericardium was wrapped around the tube at the L3-L4 region to simulate the dura mater. A small water pump was used to simulate CSF pressure and flow. A small incision was made on the bovine pericardium to simulate an incidental durotomy. A synthetic substitute to tissue was used to cover the box, and a 3D-printed tubular retractor was placed to simulate a posterior endoscopic approach. To mimic intraoperative practice, users must practice suturing the simulated dura tissue in order to provide a water-tight seal and prevent fluid leakage after closure.

### Results

An affordable and transportable simulation box that enables medical trainees to practice spinal dura repair was developed. This experience can be reproduced easily by replacing the dura substitute after each simulation, as all other aspects of the device remain intact. This device also provides haptic feedback while simultaneously simulating the intraoperative experiences. Moreover, the device also enables trainees to measure surgical performance by assessing time to repair dura, volume of CSF lost during repair, and quality of repair by recording pressure required to break the seal.

### Conclusion

Intraoperative experience conferred while training in the operating room provides neurosurgical trainees unparalleled learning opportunities compared to other methods. However, supplementing this essential practice with simulation devices may develop the advanced technical skills required to care for patients. Currently, simulation models are expensive, immobile, single-use, and/or do not provide haptic feedback. The utilization of the simulation box for lumbar dural repair will enable users to assess their performance using a device that mimics the intraoperative experience in an affordable way and may improve operative skills prior to actual operative experience.

### 3. Microdiscectomy

### Introduction

Minimally invasive surgery is becoming increasingly favorable due to patients’ reduction in postoperative pain and shorter hospital stays. In order to become proficient in these techniques, simulation exercises are beneficial to resident education. Simulation exercises in surgical residencies have been shown to foster confidence and improve trainee surgical techniques. For neurosurgical residents, the main form of practice involves cadaveric dissection. While cadavers well formulate human anatomy, the maintenance of these bodies, cost to purchase, dedicated space, and exposure to toxic chemicals are just some of the limitations.

### Methods

A box was designed using graphic software to accommodate a 3 level lumbar vertebral body model. The model was created using a de-identified patient lumbar CT scan. The CT scan was reconstructed to create a 3D model, replicating patient anatomy. A 3D lid and tubular retractor were created to house the spine model. The foam was placed around the tubular retractor to provide tactile feedback to the user.

### Results

The estimated cost of the simulator is less than $100 due to materials. A cost-effective spine simulator that mimics patient anatomy was developed and created. In addition, the simulator allows for easy transportation.

### Conclusion

It is feasible to create and develop a cost-effective microdiscectomy simulation device. In addition, the utility of the simulator can be expanded by replicating patient-specific anatomy. Further goals aim to develop a series of exercises as well as grading rubrics to assess resident improvement. In addition, it was found that the simulator can be expanded to the thoracic as well as the cervical spine. This simulator will hopefully make spine simulators more economical and convenient for neurosurgical residents.

### 4. Introduction of a Cost-Effective 3D-Printed Simulation Device For Anterior Lumbar Interbody Fusion

### Introduction

In recent years, neurosurgery has continued to experience a surge in spinal operations, with a previous study citing an increase from 68.0% to 76.8% of spine procedures relative to cranial and peripheral nerve operations from 2006 to 2013.¹ There has been a 168.5% increase in the number of Anterior lumbar interbody fusion (ALIF) procedures from 2007 to 2014.² To better prepare neurosurgical trainees for spinal operations and supplement hands-on intraoperative experience, a 3D-printed simulation device to imitate ALIF using affordable materials was developed.

### Methods

This simulation was designed using 3D modeling software and 3D-printed with PLA filament. A model spine from L3-S2 was created using a lumbar CT scan from a de-identified patient and manipulated to simulate an anterior approach to the interbody disc space. 10% ballistic gelatin was used for the trainee to practice discectomy. Polyurethane foam was included on the top of the box to simulate soft tissue. Initial materials cost under $50, with $10 to replace the disc material and model spine for continued use.

### Results

A cost-effective neurosurgical training simulation for the ALIF procedure was created. This device can be reused with low additional costs, while allowing the trainee to continually practice the technical skills required for an anterior lumbosacral approach. This can be supplemented with surgical tools available in neurosurgery departments, such as screws and interbody grafts. Performance can be measured through extent of disc resection and time to interbody placement.

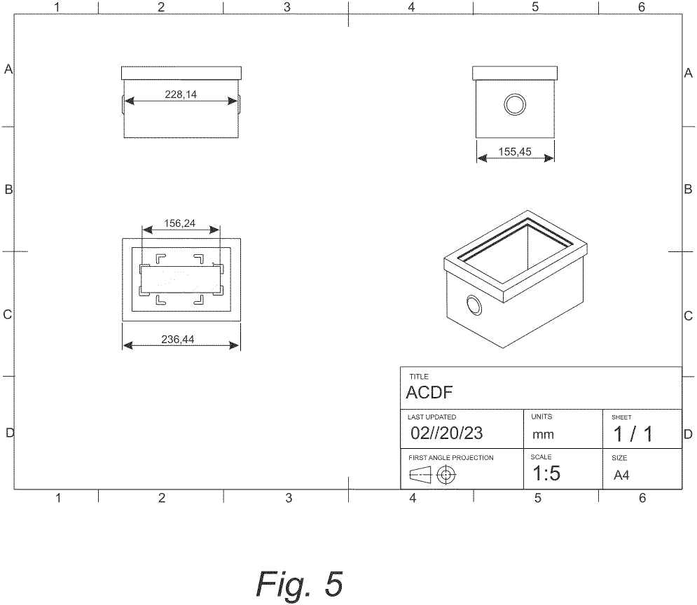

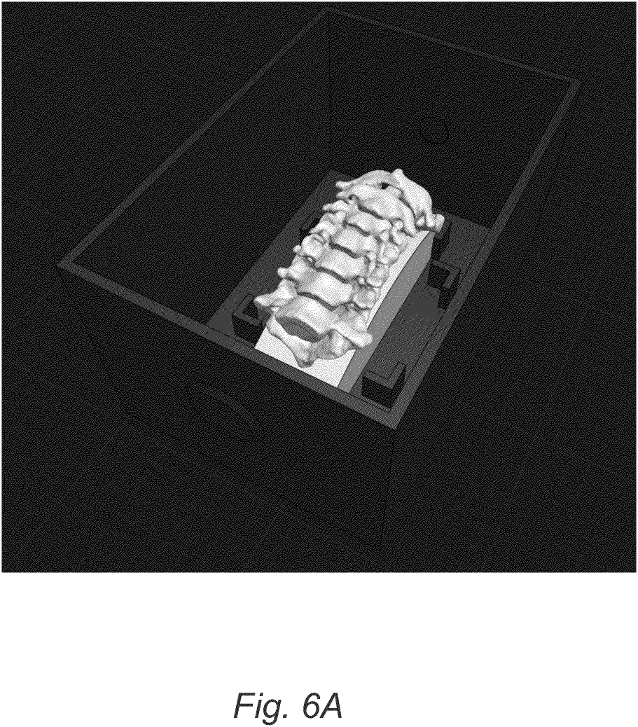

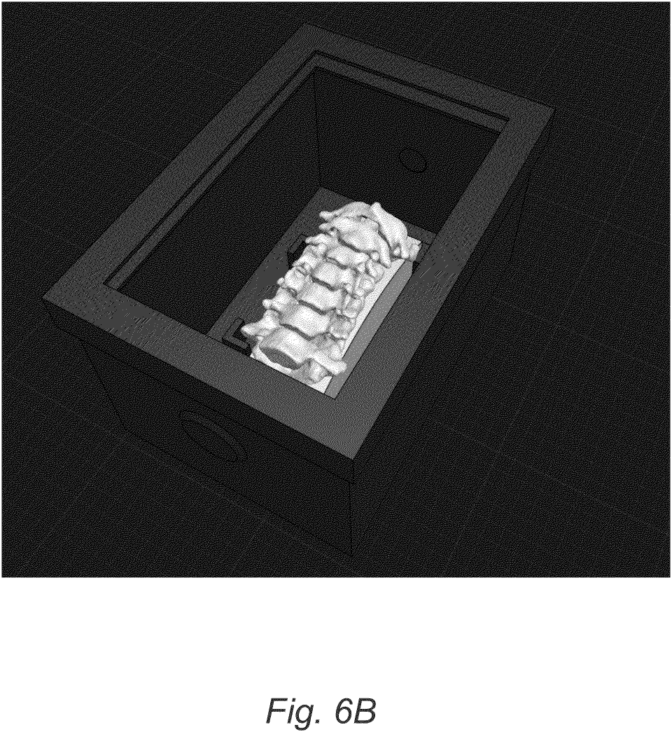

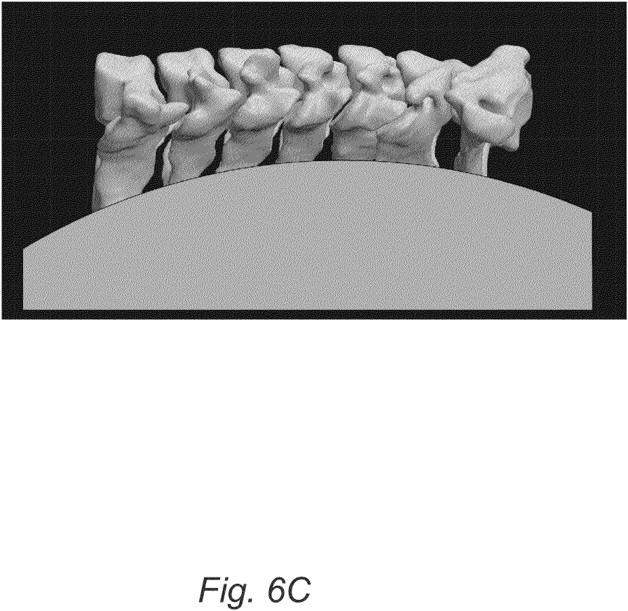

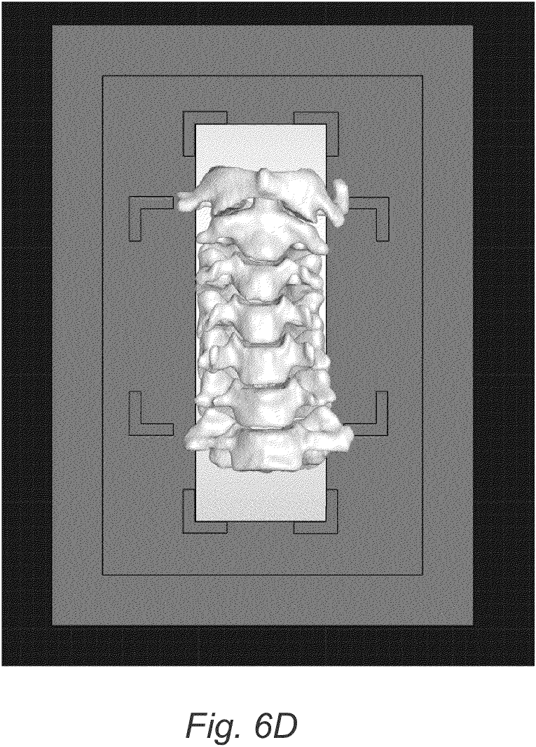

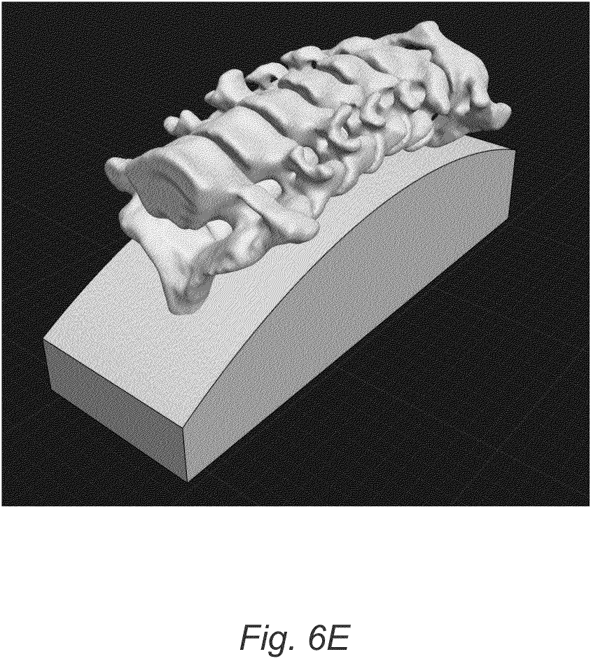

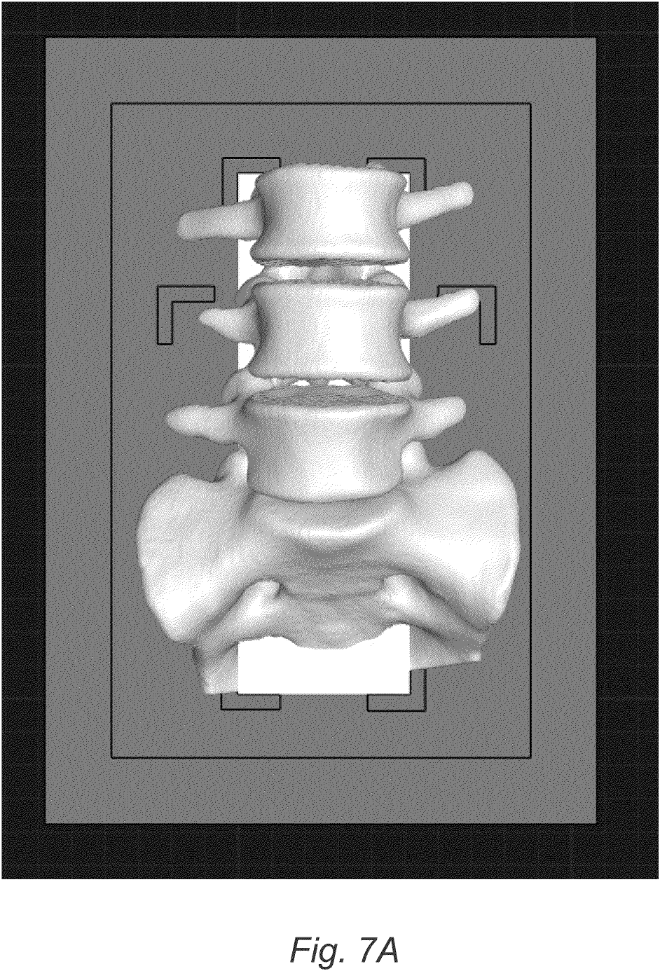

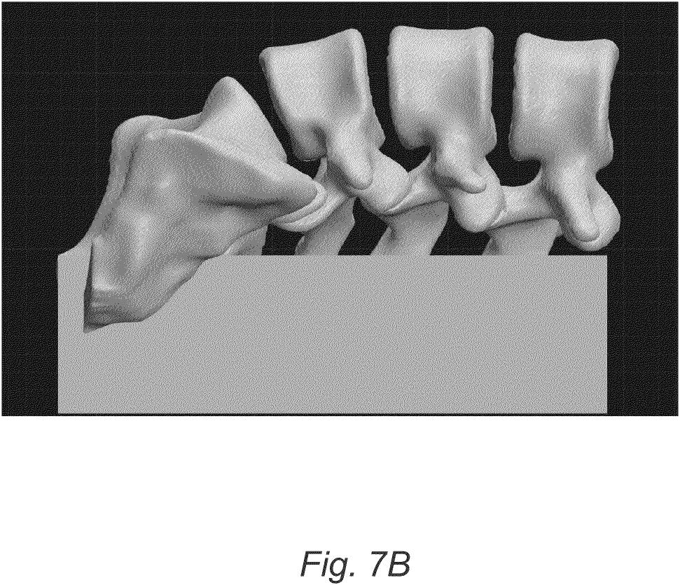

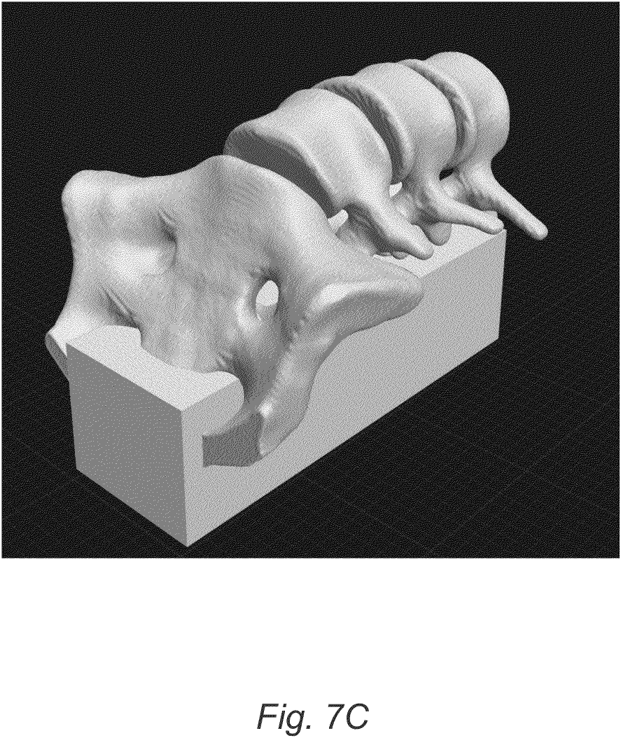

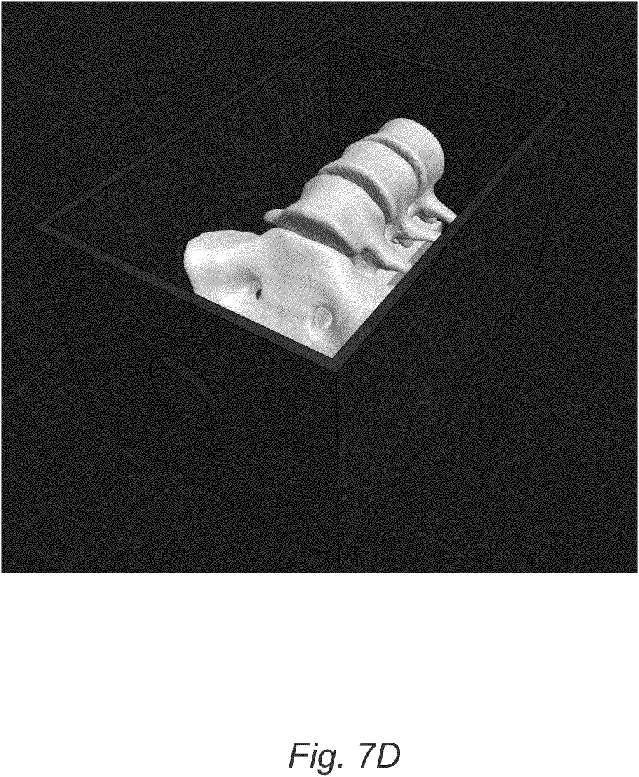

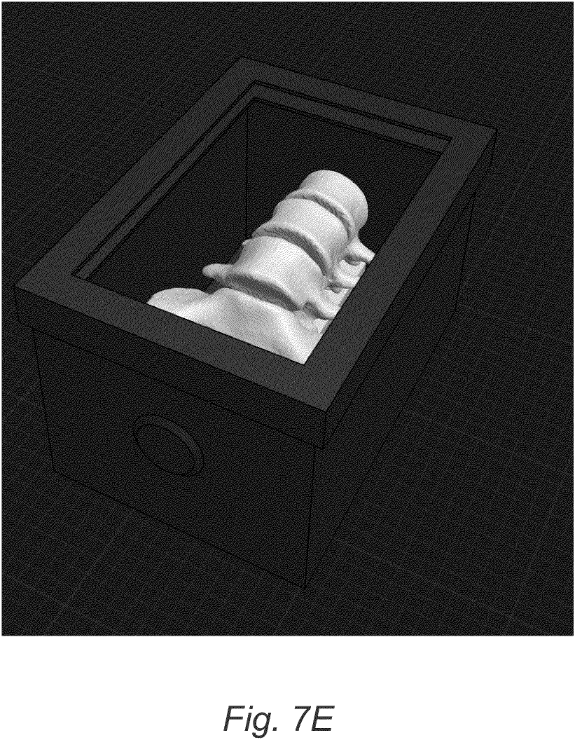

FIG. 5 provides an engineering schematic of a simulation box. FIGS. 6A, 6B, 6C, 6D, and 6E provide schematics of an anterior cervical discectomy and fusion simulation. FIGS. 7A, 7B, 7C, 7D, and 7E provide schematics of an anterior lumbar interbody fusion simulation.

### Conclusion

Although intraoperative experience remains the gold standard of neurosurgical training, simulation devices have been explored in recent years to supplement and enhance technical skills outside the operating room. Unlike other simulations, such as virtual reality and cadaveric models, a cost-effective and reusable 3D-printed device may provide a useful alternative for trainees to practice their neurosurgical techniques in a low-stress environment.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### References

1. Rolston JD, Zygourakis CC, Han SJ, Lau CY, Berger MS, Parsa AT. Medical errors in neurosurgery. Surg Neurol Int. 2014 Oct 13;5(Suppl 10):S435-40. doi: 10.4103/2152-7806.142777. PMID: 25371849; PMCID: PMC4209704.

2. Lubelski D, Mukherjee D, Theodore N. Commentary: Simulation of Dural Repair in Minimally Invasive Spine Surgery With the Use of a Perfusion-Based Cadaveric Model. Oper Neurosurg (Hagerstown). 2019 Dec 1;17(6):E231-E233. doi: 10.1093/ons/opz111. PMID: 31120106.

3. Shenoy K, Donnally CJ 3rd, Sheha ED, Khanna K, Prasad SK. An Investigation of a Novel Dural Repair Device for Intraoperative Incidental Durotomy Repair. Front Surg. 2021 Jun 30;8:642972. doi: 10.3389/fsurg.2021.642972. PMID: 34291076; PMCID: PMC8288282.

4. Cobb MI, Taekman JM, Zomorodi AR, Gonzalez LF, Turner DA. Simulation in Neurosurgery-A Brief Review and Commentary. World Neurosurg. 2016 May;89:583-6. doi: 10.1016/j.wneu.2015.11.068. Epub 2015 Dec 17. PMID: 26704209.

5. Rolston JD, Zygourakis CC, Han SJ, Lau CY, Berger MS, Parsa AT. Medical errors in neurosurgery. Surg Neurol Int. 2014 Oct 13;5(Suppl 10):S435-40. doi: 10.4103/2152-7806.142777. PMID: 25371849; PMCID: PMC4209704.

6. Homsi MT, Gaffey MM. Sinus Endoscopic Surgery. 2021 Sep 18. In: StatPearls [Internet]. Treasure Island (FL): StatPearls Publishing; 2021 Jan-. PMID: 33085349.

7. Cote DJ, Karhade AV, Larsen AM, Burke WT, Castlen JP, Smith TR. United States neurosurgery annual case type and complication trends between 2006 and 2013: An American College of Surgeons National Surgical Quality Improvement Program analysis. J Clin Neurosci. 2016 Sep;31:106-11. doi: 10.1016/j.jocn.2016.02.014. Epub 2016 May 12. PMID: 27183956.

8. Varshneya, Kunal BS; Medress, Zachary A. MD; Jensen, Michael MD, PhD; Azad, Tej D. MS; Rodrigues, Adrian BS; Stienen, Martin N. MD; Desai, Atman MD; Ratliff, John K. MD; Veeravagu, Anand MD. Trends in Anterior Lumbar Interbody Fusion in the United States: A MarketScan Study From 2007 to 2014. Clinical Spine Surgery: June 2020 - Volume 33 - Issue 5 -p E226-E230 doi: 10.1097/BSD.0000000000000904

What is claimed is:

1. A simulation device for simulating a surgical procedure comprising:
an open box;
a three-dimensional model of a bony or soft tissue anatomical structure that is positionable in the open box; and
a box cover that is positionable over the open box, the box cover having surface structures that simulate anatomical structures relevant to the surgical procedure.

2. The simulation device of claim 1, wherein the surface structures include skin, bony structures close to the skin and combination thereof.

3. The simulation device of claim 1, wherein the surface structures include structures simulating a portion of a human skull.

4. The simulation device of claim 1, wherein the three-dimensional model is divided into multiple sections held together by magnetic technology.

5. The simulation device of claim 4, wherein the magnetic technology that designed to only withstand a maximal force a surgeon should apply when performing a procedure.

6. The simulation device of claim 1, wherein the three-dimensional model is divided into multiple sections held together by protrusions and opens that receive the protrusions.

7. The simulation device of claim 1, wherein the three-dimensional model includes a replaceable component that simulates material altered or removed by the surgical procedure.

8. The simulation device of claim 7, wherein the replaceable component simulates a tumor.

9. The simulation device of claim 7, wherein the replaceable component simulates a spinal dura rupture.

10. The simulation device of claim 1, wherein the three-dimensional model is created from a patient’s imaging data.

11. The simulation device of claim 1, configured to simulate spinal surgical procedures.

12. The simulation device of claim 11, wherein the spinal surgical procedures include spinal dura repair or microdiscectomy.

13. The simulation device of claim 11 further comprising a plastic tube to mimic a patient’s spinal canal.

14. The simulation device of claim 11, wherein water is pumped through plastic tube to simulate cerebrospinal fluid (CSF) pressure and flow.

15. The simulation device of claim 13, wherein a portion of the plastic tube is surrounded by a dura substitute material to simulate spinal dura.

16. The simulation device of claim 15, wherein the dura substitute material includes a component selected from the group consisting of bovine pericardium was used as a dura substitute, leather, oriented polypropylene wrapping, chicken skin, and latex.

17. The simulation device of claim 15, wherein a small incision is made on the dura substitute material to simulate an incidental durotomy.

18. The simulation device of claim 11, wherein the surface structures includes a synthetic covering that mimics skin and provide a narrow surgical viewing plane.

19. The simulation device of claim 18, wherein materials for the synthetic covering include foam insulation, silicone, or ballistics gel.

20. The simulation device of claim 11 further comprising a tubular retractor that is placed on the box cover to simulate an endoscopic approach to a patient’s spine from a patient’s back.

21. The simulation device of claim 1 configured to simulate transsphenoidal hypophysectomy.

22. The simulation device of claim 21, wherein the surface structures simulates a first portion of a human skull and the three-dimensional model simulates a second portion of the human skull.

23. The simulation device of claim 21, wherein the three-dimensional model includes a plastic structure simulating a pituitary gland.
